(19) United States
(12) Patent Application Publication
(10) Pub. No.: US 2011/0268132 A1
(43) Pub. Date: Nov. 3, 2011

(54) DEVICE AND METHOD FOR TRANSMISSION OF TDM SIGNAL OVER ASYNCHRONOUS NETWORK

(76) Inventor: YOSHIHARU KOBATAKE, Tokyo (JP)

(21) Appl. No.: 13/093,107

(22) Filed: Apr. 25, 2011

(30) Foreign Application Priority Data
Apr. 28, 2010 (JP) 2010-103110

(51) Int. Cl. H04L 12/43

(52) U.S. Cl. 370/458

(57) ABSTRACT

A transmission device which transmits a packet to a destination transmission device through an asynchronous network, the packet accommodating a plurality of time division multiplexing (TDM) channels, includes: an unused-channel information storage section for storing unused-channel information on an unused one of a predetermined number of TDM channels; and an unused channel deletion section for deleting an unused channel from the predetermined number of TDM channels accommodated in a received packet by referring to the unused-channel information, to generate a compressed packet to transmit to the destination transmission device.

This application is based upon and claims the benefit of priority from Japanese Patent Application No. 2010-103110, filed on Apr. 28, 2010, the disclosure of which is incorporated herein in its entirety by reference.

### BACKGROUND OF THE INVENTION

1. Field of the Invention

The present invention relates to pseudo wire emulation edge to edge (hereinafter, referred to as “PWE3”) technology and, more particularly, to a device and method for transmission of a time-division-multiplexed signal over a asynchronous network such as an Ethernet™ (hereinafter, simply referred to as “Ether”) and a packet-switched network.

2. Description of the Related Art

Various circuit emulation technologies are proposed to transport time division multiplexing (TDM) circuits over an asynchronous network such as a packet network (for example, see Japanese Patent Application Unexamined Publication No. 2008-135819). Particularly in Request for Comments: 4553 “Structure-Agnostic Time Division Multiplexing (TDM) over Packet (SAToP),” June 2006, a pseudo wire technology is described in which TDM bit streams (T1, E1, T3, E3) are capsulated disregarding the structure of the bit streams, and the specifications of SAToP are recommended. According to SAToP, all time slots of TDM circuits are mapped into the payloads of IP packets and transferred over a packet network. Hereinafter, SAToP will he described briefly with reference to FIGS. 1 and 2.

Referring to FIG. 1A, by means of TDM pseudo wire emulation technology, a TDM pipe is formed over a packet network, so that TDM circuits are connected in a pseudo manner. According to SAToP, all T1/E1 time slots including TDM circuit framing bits/bytes are mapped into the payloads of IP packets as shown in FIG. 1B. For example, a DS1/T1 frame bundling 24 DS0 channels is stored as it is into a payload, which is then, with a packet header added thereto, sent out to a packet network. Note that T1 and E1 frames have the formats shown in FIGS. 2A and 2B, respectively.

However, not all time slots are necessarily used in TDM circuits. Therefore, the presence of an unused channel results in meaningless data being stored in a payload, which leads to a decrease in data transfer efficiency and a decrease in network bandwidth usage efficiency in a packet network.

### SUMMARY OF THE INVENTION

An object of the present invention is to provide a transmission device and a transmission method that can increase packet transfer efficiency and achieve efficient use of the bandwidth of an asynchronous network even when there is an unused channel.

According to the present invention, a transmission device for transmitting a packet to a destination transmission device through an asynchronous network, the packet accommodating a plurality of time division multiplexing (TDM) channels, includes: an unused-channel information storage section for storing unused-channel information on an unused one of a predetermined number of TDM channels; and an unused channel deletion section for deleting an unused channel from the predetermined number of TDM channels accommodated in a received packet by referring to the unused-channel information, to generate a compressed packet to transmit to the destination transmission device.

According to the present invention, a transmission device for receiving a packet from a source transmission device through an asynchronous network, the packet accommodating a plurality of time division multiplexing (TDM) channels, includes: an unused-channel information storage section for storing unused-channel information on an unused one of a predetermined number of TDM channels; and an unused channel restoration section for restoring an unused channel from the plurality of TDM channels accommodated in a received compressed packet by referring to the unused-channel information, to generate a standard-compliant packet accommodating the predetermined number of TDM channels.

According to the present invention, a transmission method of transmission of a packet from a sending-side transmission device to a receiving-side transmission device through an asynchronous network, the packet accommodating a plurality of time division multiplexing (TDM) channels, includes the steps of: at the sending-side transmission device, storing unused-channel information on an unused one of a predetermined number of TDM channels; receiving a standard-compliant packet accommodating the predetermined number of TDM channels; deleting an unused channel from the predetermined number of TDM channels accommodated in the received standard-compliant packet by referring to the unused-channel information, to generate a compressed packet; transmitting the compressed packet to the receiving-side transmission device; at the receiving-side transmission device, storing the unused-channel information; receiving the compressed packet from the sending-side transmission device; and restoring the unused channel from the plurality of TDM channels accommodated in the received compressed packet by referring to the unused-channel information, to generate a standard-compliant packet accommodating the predetermined number of TDM channels.

According to the present invention, it is possible to increase packet transfer efficiency and achieve efficient use of the bandwidth of an asynchronous network even when there is an unused channel.

### BRIEF DESCRIPTION OF THE DRAWINGS

FIG. 1A is a schematic diagram for describing the concept of TDM pseudo wire.

FIG. 1B is a schematic diagram showing the relationship between time slots and a packet payload according to SAToP.

FIG. 2A is a diagram of a T1 frame format.

FIG. 2B is a diagram of an E1 frame format.

FIG. 3 is a block diagram showing the functional structure of a SAToP transmission system according to an exemplary embodiment of the present invention.

FIG. 4 is a block diagram showing the functional configurations of TDM_over_Ether transmission devices according to an example of the present invention.

FIG. 5A is a schematic diagram showing an example of unused-channel information for the sending side.

FIG. 5B is a schematic diagram showing an example of unused-channel information for the receiving side.

FIG. 6 is a flowchart showing Ether frame transmission control operation by the sending-side transmission device shown in FIG. 4.

FIG. 7A is a schematic diagram showing an example of unused-channel information.

FIG. 7B is a schematic diagram showing a frame structure, to describe an operation of generating a compressed frame and an operation of restoring a normal frame.

FIG. 8 is a schematic diagram showing an Ether frame generated by the sending-side transmission device as shown in FIG. 6, as well as the structure of a control word in the frame.

FIG. 9 is a flowchart showing Ether frame transmission control operation by the receiving-side transmission device shown in FIG. 4.

FIG. 10 is a block diagram showing an example of the functional configuration of a transmission device according to another example of the present invention.

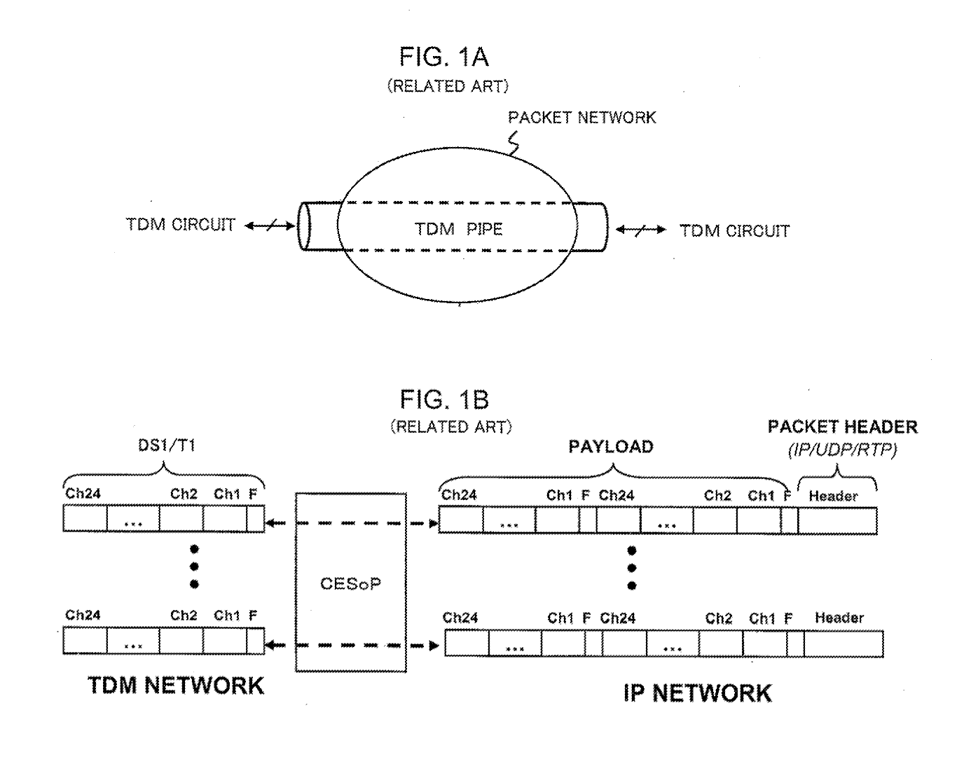

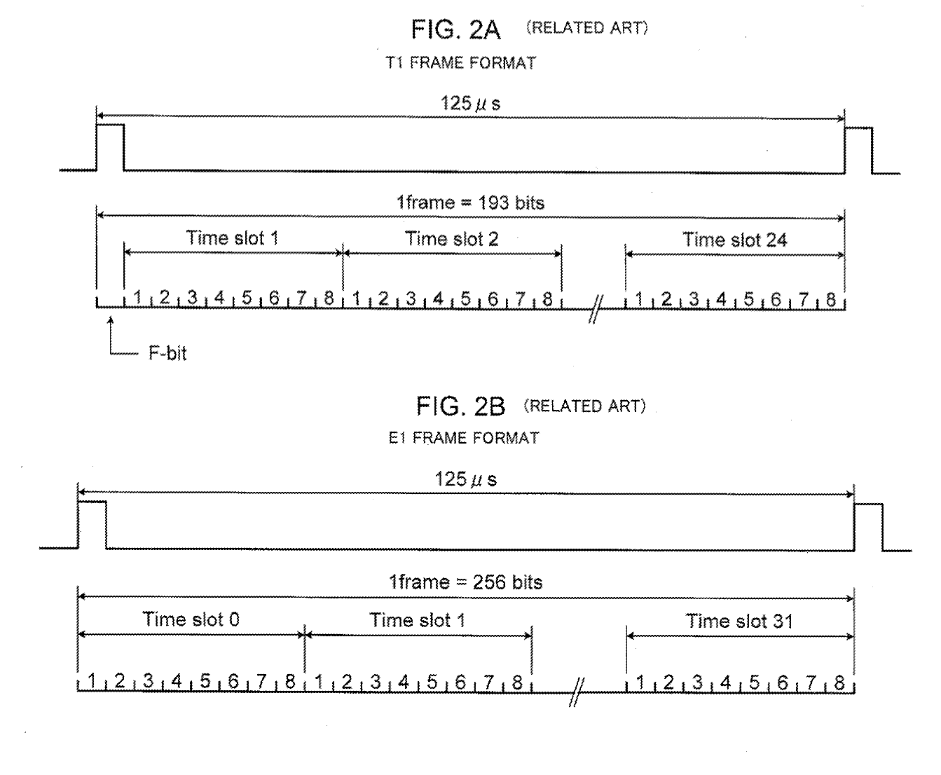

### DETAILED DESCRIPTION OF THE PREFERRED EMBODIMENTS

### 1. Exemplary Embodiment

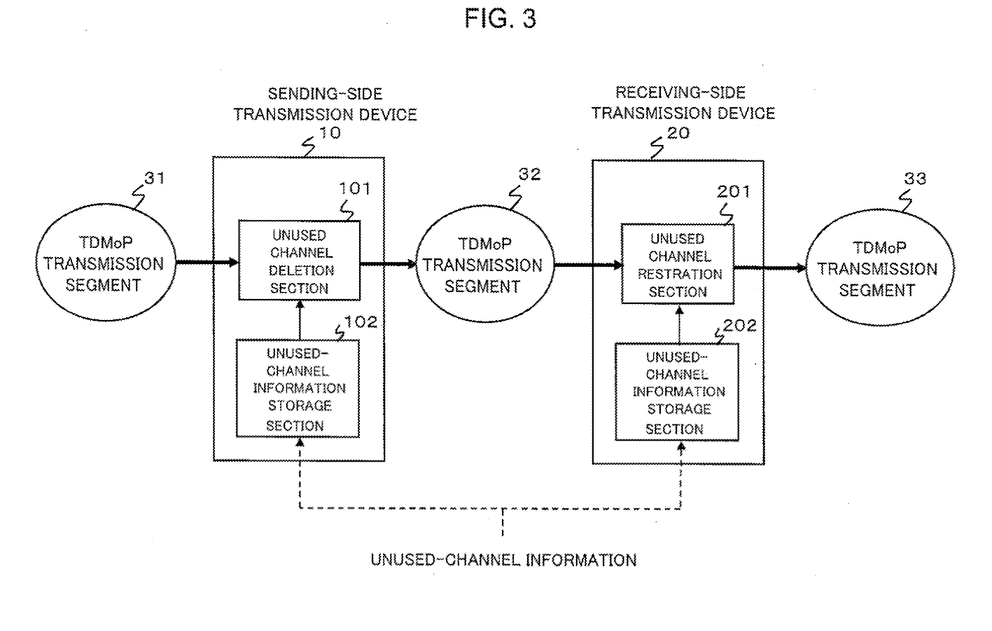

Referring to FIG. 3, a SAToP transmission system according to an exemplary embodiment of the present invention includes a sending-side transmission device 10 and a receiving-side transmission device 20 along TDMoP (TDM over Packet) transmission segments each of which is formed across a packet network by using the TDM pseudo wire emulation technology. Here, it is assumed that the sending-side transmission device 10 is located between TDMoP transmission segments 31 and 32 and that the receiving-side transmission device 20 is located between the TDMoP transmission segment 32 and a TDMoP transmission segment 33. Note that the packet network is an example of asynchronous networks and that the sending-side transmission device 10 and receiving-side transmission device 20 in FIG. 3 only show their respective functional configurations related to a transmission device according to the present exemplary embodiment.

The sending-side transmission device 10 includes an unused channel deletion section 101 which deletes payload information corresponding to an unused TDM channel from a SAToP packet and a storage section 102 which stores information on the unused channel (unused-channel information). The unused channel deletion section 101 refers to the unused-channel information in the unused-channel information storage section 102, deletes the information of an unused channel from a SAToP packet received from the TDMoP transmission segment 31, generates a compressed SAToP packet non-compliant with standards, and then transmits the packet to the TDMoP transmission segment 32. It should be noted that the term “packet” in the present disclosure indicates a block of collective information.

The receiving-side transmission device 20 includes an unused channel restoration section 201 which restores payload information corresponding to an unused TDM channel in a SAToP packet and a storage section 202 which stores information on the unused channel (unused-channel information). The unused channel restoration section 201 refers to the unused-channel information in the unused-channel information storage section 202, restores the information of an unused channel in a compressed SAToP packet received from the TDMoP transmission segment 32, and transmits a SAToP packet compliant with standards to the TDMoP transmission segment 33. To distinguish between a compressed SAToP packet non-compliant with standards and a SAToP packet compliant with standards, it is sufficient to use part of control information (for example, a reserved area) in a packet header.

The unused-channel information stored in the sending-side unused-channel information storage section 102 is the same as the unused-channel information stored in the receiving-side unused-channel information storage section 202. This information is stored when a TDMoP transmission segment is set up, for example. To perform SAToP communication, settings of a destination, a channel to be transmitted, and the like usually need to he made on both the sending- and receiving-side devices when a circuit is newly established or a change is made in a circuit, at which time the unused-channel information is also set.

As described above, transmission over a TDMoP transmission segment is performed with the information of an unused channel being deleted from a normal SAToP packet, whereby it is possible to reduce a bandwidth required for SAToP transmission in a packet network, and it is possible to achieve efficient use of the network bandwidth.

### 2. EXAMPLE

Hereinafter, an example of the present invention will be described in detail by illustrating an Ether frame as a SAToP packet.

### 2.1) Structure and Configuration

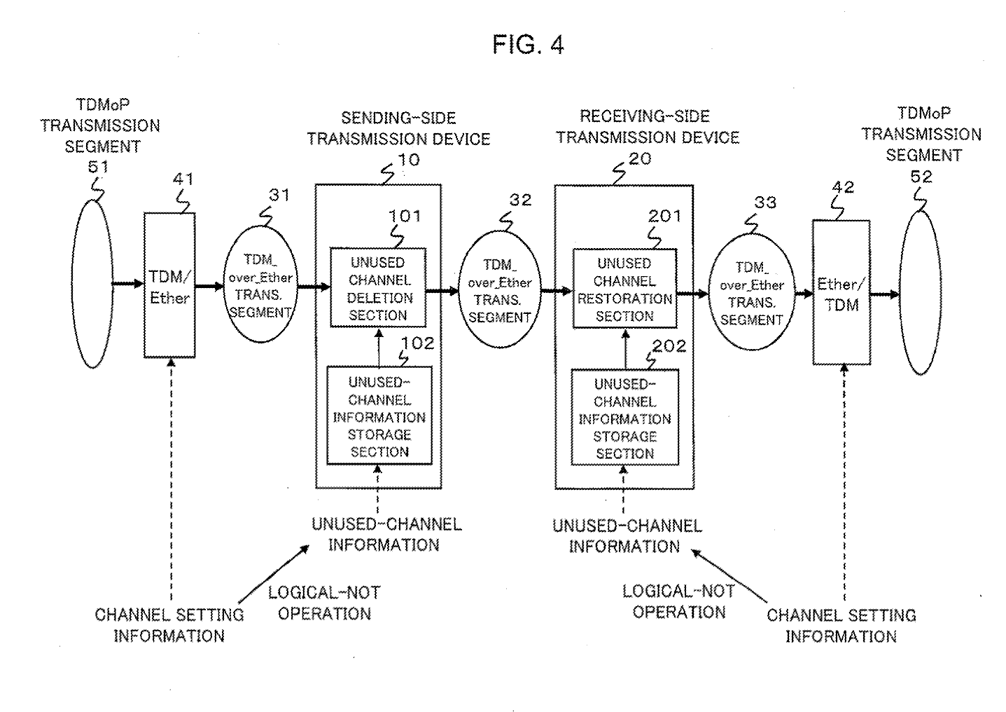

In a TDM_over_Ether system shown in FIG. 4, TDM transmission segments 51 and 52 represent communication links over which communications are performed by using TDM transmission schemes. A TDM/Ether conversion section 41 represents a general device which converts data received in TDM transmission schemes into PWE3 data and transmits the data to a TDM_over_Ether transmission segment 31. Moreover, an

Ether/TDM conversion section 42 represents a general device which converts PWE3 data into data in TDM transmission schemes and transmits the data to the TDM transmission segment 52.

The TDM_over_Ether transmission segment 31 and TDM_over_Ether transmission segments 32 and 33 are communication lines over which communications can be performed using pseudo wire emulation (PWE3). Since these TDM_over_Ether transmission segments 31 to 33 correspond to the TDMoP transmission segments 31 to 33 shown in FIG. 3, respectively, the same reference numerals are used, and a description thereof will be omitted.

A sending-side transmission device 10 and a receiving-side transmission device 20 also correspond to the sending-side transmission device 10 and receiving-side transmission device 20 in FIG. 3, respectively, and therefore the same reference numerals are used. That is, the sending-side transmission device 10 includes an unused channel deletion section 101 and an unused-channel information storage section 102, and the receiving-side transmission device 20 includes an unused channel restoration section 201 and an unused-channel information storage section 202. Sending-side functionality and receiving-side functionality are capable of parallel operations independently of each other.

Note that FIG. 4 only show those functions related to the present example. The unused channel deletion section 101 of the sending-side transmission device 10 can also realize functionality equivalent to under-mentioned control by executing a program on a program-controlled processor such as a central processing unit (CPU) of the transmission device 10. The same is the case with the unused channel restoration section 201 of the receiving-side transmission device 20.

### 2.2) Unused-Channel Information

To perform SAToP communications, it is necessary to set channel setting information indicating a destination address, a channel to be transmitted, and the like on both the sending-side TDM/Ether conversion section 41 and the receiving-side Ether/TDM conversion section 42 when a circuit is newly established or a change is made in a circuit. In the event of setting this channel setting information, unused-channel information can be set manually or automatically on the sending-side transmission device 10 and receiving-side transmission device 20.

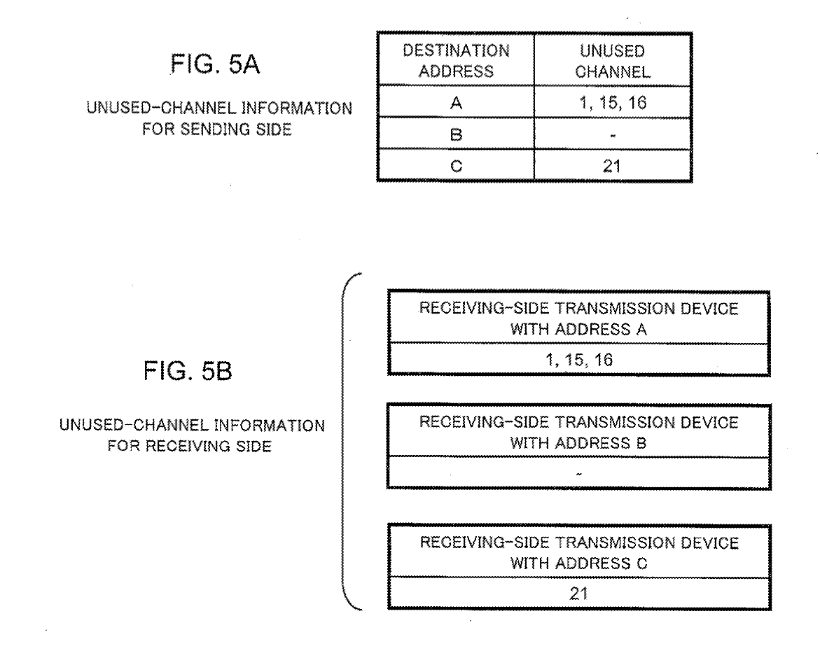

In the unused-channel information storage section 102 of the sending-side transmission device 10, identification information on an unused channel or unused channels is stored for each destination transmission device, as shown in FIG. 5A. Referring to FIG. 5A, for example, channels #1, #15, and #16 are unused between the sending-side transmission device 10 and a transmission device with address A. Therefore, a frame can be compressed by as many time slots as correspond to these channels and then transmitted.

In the unused-channel information storage section 202 of the receiving-side transmission device 20, information on an unused channel or unused channels with the sending-side transmission device 10 is stored, as shown in FIG. 5B. Referring to FIG. 5B, for the transmission device with address A, for example, channels #1, #15, and #16 are unused with the sending-side transmission device 10. Therefore, when a compressed frame is received from the sending-side transmission device 10, a normal frame can be generated by restoring as many time slots as correspond to these channels and then transmitted to the Ether/TDM conversion section 42.

The unused-channel information for the sending-side transmission device 10 and receiving-side transmission device 20 can also be automatically generated from the channel setting information set on the TDM/Ether conversion section 41 and Ether/TDM conversion section 42. For example, it is assumed that the TDM/Ether conversion section 41 and sending-side transmission device 10 are accommodated in a single device and that the Ether/TDM conversion section 42 and receiving-side transmission device 20 are accommodated in a single device.

For the sending-side TDM/Ether conversion section 41 to communicate with the receiving-side Ether/TDM conversion section 42, as described above, a destination MAC address, transmission channel information, and the like are set on the sending side, while the MAC address of the own device, reception channel information, and the like are set on the receiving side that is the destination in question. Unused-channel information is automatically generated based on these pieces of channel setting information. Specifically, channels other than those to be transmitted (transmission channels) are listed as unused channels for each destination MAC address on the sending side. Similarly, channels other than the transmission channels specified by the MAC address of the own device and channel setting information are listed as unused channels on the receiving side as well. As long as the transmission channels can be communicated, it can be determined that channel settings on the TDM/Ether conversion section 41 and on the Ether/TDM conversion section 42 are correctly made, and accordingly the unused-channel information can be treated as correct information.

A detailed description will be given of Ether frame transmission control on each of the sending side and receiving side in a state where synchronization as to the unused-channel information is thus established between the sending side and receiving side.

### 2.3) Ether Frame Transmission Control on the Sending Side

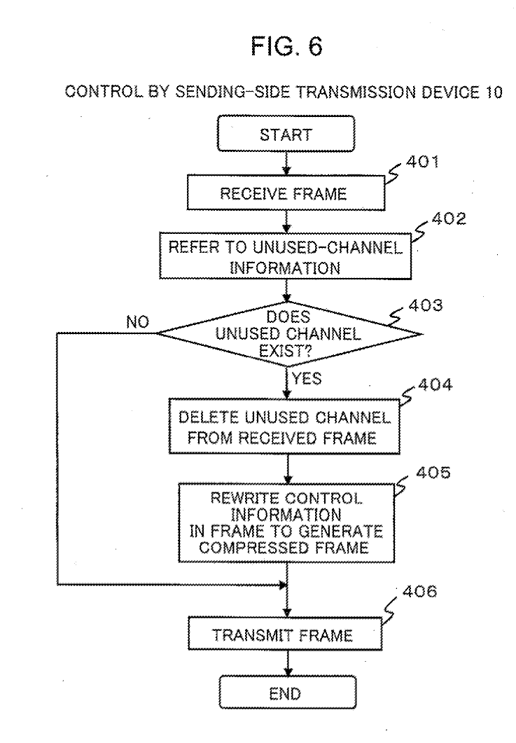

Hereinafter, Ether frame transmission control operation performed by the sending-side transmission device 10 will be described with reference to FIGS. 6 to 8.

Referring to FIG. 6, when the sending-side transmission device 10 receives a normal Ether frame compliant with standards from the TDM_over_Ether transmission segment 31 (Step 401), the unused channel deletion section 101 implemented on a program-controlled processor refers to the unused-channel information stored in the unused-channel information storage section 102 (Step 402) and determines whether or not an unused channel exists (Step 403). When at least one unused channel exists (Step 403: YES), the unused channel deletion section 101 deletes those time slots (channel data) corresponding to the unused channels from the received Ether frame (Step 404) and further rewrites control information in the frame, thereby generating a compressed Ether frame (Step 405). For the control information in the frame, it is sufficient that the information is indicative of a compressed frame. Here, a reserved (RSV) area in the control word is rewritten to have a unique pattern (for example, “11” or the like).

The sending-side transmission device 10 transmits the compressed Ether frame thus generated, or the received Ether frame when no unused channel exists (Step 403: NO), to the TDM_over_Ether transmission segment 32 (Step 406).

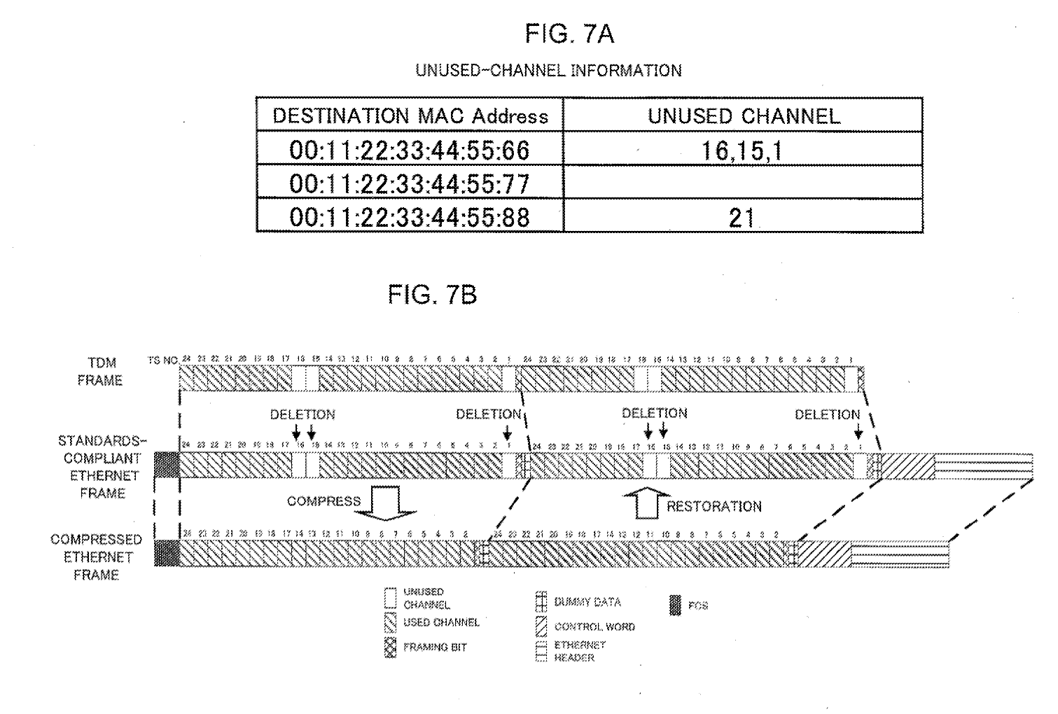

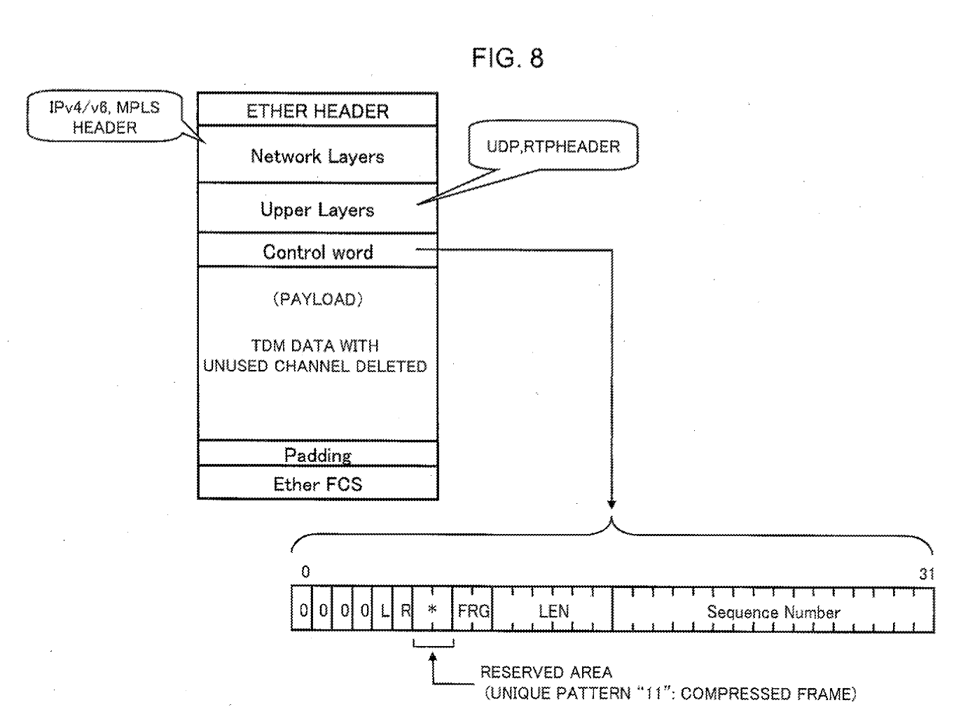

It is assumed that an unused-channel setting is made for each of the MAC addresses of destination transmission devices, as shown in FIG. 7A. For example, for the destination transmission device with destination MAC address “00:11:22:33:44:55:66”, channels corresponding to time slots #1, #15, and #16 are unused, of the 24 channels in each TDM frame. Therefore, the channel data in the time slots #1, #15, and #16 are deleted as shown in FIG. 7B, thereby generating a compressed Ether frame. In this event, as shown in FIG. 8, the unique pattern “11” is written into the reserved area in the control word, whereby the frame can be identified as a compressed Ether frame.

### 2.4) Ether Frame Transmission Control on the Receiving Side

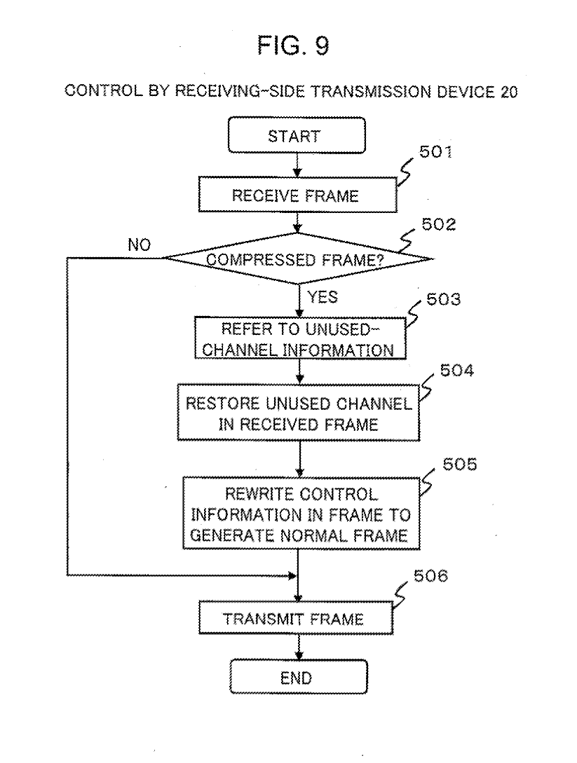

Hereinafter, Ether frame transmission control operation performed by the receiving-side transmission device 20 will be described with reference to FIG. 9.

Referring to FIG. 9, when the receiving-side transmission device 20 receives a compressed Ether frame from the TDM_over_Ether transmission segment 32 (Step 501), the unused channel restoration section 201 implemented on a program-controlled processor checks the reserved area in the control word of the received frame and determines whether or not the frame is a compressed frame (Step 502). When the frame is a compressed frame (Step 502: YES), the unused channel restoration section 201 refers to the unused-channel information in the unused-channel information storage section 202 (Step 503), restores channel data in those time slots corresponding to the unused channels (Step 504), and further changes the value of the reserved area in the control word of the frame back to a default value (“00” or the like), thereby generating a normal SAToP-compliant Ether frame (Step 505).

The receiving-side transmission device 20 transmits the thus restored Ether frame, or the received normal Ether frame (Step 502: NO), to the TDM_over_Ether transmission segment 33 (Step 506).

### 2.5) Effects

A description will be given of advantageous effects achieved when the transmission processing according to the present example is performed on a received Ether frame of PWE3 converted from a TDM frame of T1 as shown in FIG. 7B.

For example, although a total of 24 channels are accommodated in one frame when a TDM frame is a T1 frame, it is assumed that only 21 channels are actually used, with the other three channels being unused (here, time slots #16, #15, and #1 as shown in FIG. 7A). This TDM frame has a size of 193 bits (=8 bits×24 channels+1 framing bit).

If the TDM/Ether conversion section 41 performs a conversion to have one Ether frame accommodate two TDM frames as shown in FIG. 7B, an Ether frame (compliant with standards) with a size of 576 bits (72 bytes) in total is obtained by adding to the above-described TDM frames (193 bits×2) a control word (32 bits), an Ether header (112 bits), FCS (32 bits), and dummy data (7 bits×2) for allowing the frame to be counted in bytes. The frame can be compressed to a frame size of 528 bits (66 bytes) by deleting the unused channels (three channels per TDM frame) from this Ether frame (576 bits−8 bits×6 channels [3 unused channels×2 frames]). The use of a compressed Ether frame with a compressed frame size makes efficient use of bandwidth possible.

A circuit emulation device disclosed in Japanese Patent Application Unexamined Publication No. 2008-135819 uses a scheme of deleting an unused channel when converting a TDM frame into an Ether frame and therefore cannot deal with an already-converted TDM_over_Ether frame. On the other hand, according to the present example, it is possible to delete an unused channel within a TDM_over_Ether frame. Therefore, it is not necessary to replace an existing device, and efficient use of bandwidth can be achieved only by additionally providing the transmission devices 10 and 20 according to the present example at the start and end points of a transmission segment, respectively.

### 3. Other Examples

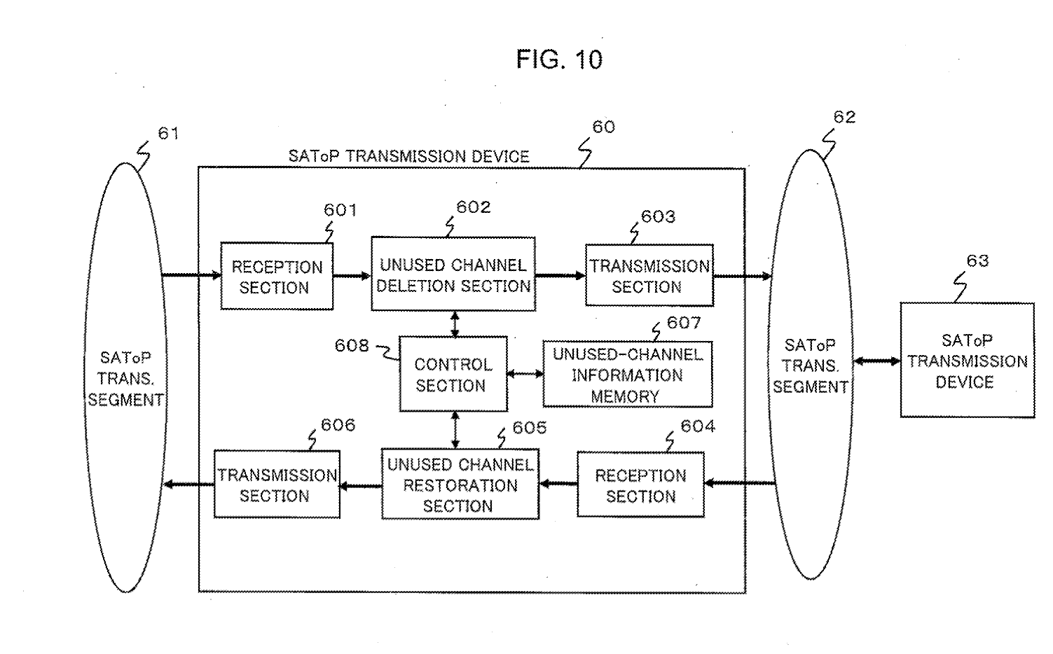

Referring to FIG. 10, a SAToP transmission device 60 according to another example of the present invention is located between SAToP transmission segments 61 and 62 and transmits/receives SAToP packets. Specifically, the SAToP transmission device 60 can include: a transmission system comprised of a reception section 601, an unused channel deletion section 602, and a transmission section 603; a reception system comprised of a reception section 604, an unused channel restoration section 605, and a transmission section 606; an unused-channel information memory 607 storing information on an unused channel or unused channels predetermined between the SAToP transmission device 60 and a SAToP transmission device 63 on the other end of a communication line; and a control section 608 for controlling the operation of the SAToP transmission device 60. In this case, the operations of the unused channel deletion section 602 and unused channel restoration section 605 are basically similar to the operation of the unused channel deletion section 101 of the sending-side transmission device 10 and the operation of the unused channel restoration section 201 of the receiving-side transmission device 20 as described above, respectively, and therefore a description thereof will be omitted.

### 4. Supplementary Notes

The whole or part of the above-described exemplary embodiments and examples can also be expressed as, but not limited to, the following supplementary notes.

### (Supplementary Note 1)

A transmission device for transmitting a packet to a destination transmission device through an asynchronous network, the packet accommodating a plurality of time division multiplexing (TDM) channels, comprising:
an unused-channel information storage section for storing unused-channel information on an unused one of a predetermined number of TDM channels; and
an unused channel deletion section for deleting an unused channel from the predetermined number of TDM channels accommodated in a received packet by referring to the unused-channel information, to generate a compressed packet to transmit to the destination transmission device.

### (Supplementary Note 2)

The transmission device according to supplementary note 1, wherein the unused channel deletion section deletes a time slot corresponding to the unused channel to generate the compressed packet.

### (Supplementary Note 3)

The transmission device according to supplementary note 1 or 2, wherein the unused-channel information indicates an unused channel for each destination transmission device.

### (Supplementary Note 4)

The transmission device according to one of supplementary notes 1-3, wherein the unused-channel information is determined based on channel setting information set in a pseudo wire emulation device which converts TDM data to pseudo wire emulation data.

### (Supplementary Note 5)

The transmission device according to one of supplementary notes 1-4, wherein the asynchronous network is a packet network or an Ethernet-compliant network.

### (Supplementary Note 6)

A transmission device for receiving a packet from a source transmission device through an asynchronous network, the packet accommodating a plurality of time division multiplexing (TDM) channels, comprising:
an unused-channel information storage section for storing unused-channel information on an unused one of a predetermined number of TDM channels; and
an unused channel restoration section for restoring an unused channel from the plurality of TDM channels accommodated in a received compressed packet by referring to the unused-channel information, to generate a standard-compliant packet accommodating the predetermined number of TDM channels.

### (Supplementary Note 7)

The transmission device according to supplementary note 6, wherein the unused channel restoration section adds a time slot corresponding to the unused channel to time slots each corresponding to the plurality of TDM channels, to generate the standard-compliant packet.

### (Supplementary Note 8)

The transmission device according to supplementary note 6 or 7, wherein the unused-channel information is determined based on channel setting information set in a pseudo wire emulation device which converts pseudo wire emulation data to TDM data.

### (Supplementary Note 9)

The transmission device according to one of supplementary notes 6-8, wherein the asynchronous network is a packet network or an Ethernet-compliant network.

### (Supplementary Note 10)

A transmission method of transmission of a packet from a sending-side transmission device to a receiving-side transmission device through an asynchronous network, the packet accommodating a plurality of time division multiplexing (TDM) channels, comprising:
at the sending-side transmission device,
   storing unused-channel information on an unused one of a predetermined number of TDM channels;
   receiving a standard-compliant packet accommodating the predetermined number of TDM channels;
   deleting an unused channel from the predetermined number of TDM channels accommodated in the received standard-compliant packet by referring to the unused-channel information, to generate a compressed packet;
   transmitting the compressed packet to the receiving-side transmission device;
at the receiving-side transmission device,
   storing the unused-channel information;
   receiving the compressed packet from the sending-side transmission device; and
   restoring the unused channel from the plurality of TDM channels accommodated in the received compressed packet by referring to the unused-channel information, to generate a standard-compliant packet accommodating the predetermined number of TDM channels.

### (Supplementary Note 11)

The transmission method according to supplementary note 10, wherein the compressed packet is generated by deleting a time slot corresponding to the unused channel and the standard-compliant packet is generated by adding a time slot corresponding to the unused channel to time slots each corresponding to the plurality of TDM channels accommodated in the received compressed packet.

### (Supplementary Note 12)

The transmission method according to supplementary note 10 or 11, wherein the unused-channel information indicates an unused channel for each destination transmission device.

### (Supplementary Note 13)

The transmission method according to one of supplementary notes 10-12, wherein the unused-channel information is determined based on channel setting information set in a pseudo wire emulation device which makes conversion between TDM data and pseudo wire emulation data.

### (Supplementary Note 14)

The transmission method according to one of supplementary notes 10-13, wherein the asynchronous network is a packet network or an Ethernet-compliant network.

### (Supplementary Note 15)

A transmission method for transmitting a packet to a destination transmission device through an asynchronous network, the packet accommodating a plurality of time division multiplexing (TDM) channels, comprising:
storing unused-channel information on an unused one of a predetermined number of TDM channels; and
deleting an unused channel from the predetermined number of TDM channels accommodated in a received packet by referring to the unused-channel information, to generate a compressed packet to transmit to the destination transmission device.

### (Supplementary Note 16)

The transmission method according to supplementary note 15, wherein a time slot corresponding to the unused channel is deleted to generate the compressed packet.

### (Supplementary Note 17)

The transmission method according to supplementary note 15 or 16, wherein the unused-channel information indicates an unused channel for each destination transmission device.

### (Supplementary Note 18

The transmission method according to one of supplementary notes 15-17, wherein the unused-channel information is determined based on channel setting information set in a pseudo wire emulation device which converts TDM data to pseudo wire emulation data.

### (Supplementary Note 19)

The transmission method according to one of supplementary notes 15-18, wherein the asynchronous network is a packet network or an Ethernet-compliant network.

### (Supplementary Note 20)

A transmission method for receiving a packet from a source transmission device through an asynchronous network, the packet accommodating a plurality of time division multiplexing (TDM) channels, comprising:
storing unused-channel information on an unused one of a predetermined number of TDM channels; and
restoring an unused channel from the plurality of TDM channels accommodated in a received compressed packet by referring to the unused-channel information, to generate a standard-compliant packet accommodating the predetermined number of TDM channels.

### (Supplementary Note 21)

The transmission method according to supplementary note 20, wherein a time slot corresponding to the unused channel is added to time slots each corresponding to the plurality of TDM channels, to generate the standard-compliant packet.

### (Supplementary Note 22)

The transmission method according to supplementary note 20 or 21, wherein the unused-channel information is determined based on channel setting information set in a pseudo wire emulation device which converts pseudo wire emulation data to TDM data.

### (Supplementary Note 23)

The transmission method according to one of supplementary notes 20-22, wherein the asynchronous network is a packet network or an Ethernet-compliant network.

### (Supplementary Note 24)

A transmission system for transmission of a packet from a sending-side transmission device to a receiving-side transmission device through an asynchronous network, the packet accommodating a plurality of time division multiplexing (TDM) channels, comprising:
at the sending-side transmission device,
   a first unused-channel information storage section for storing unused-channel information on an unused one of a predetermined number of TDM channels; and
   an unused channel deletion section for deleting an unused channel from the predetermined number of TDM channels accommodated in a received packet by referring to the unused-channel information, to generate a compressed packet to transmit to the destination transmission device.
at the receiving-side transmission device,
   an unused-channel information storage section for storing unused-channel information on an unused one of a predetermined number of TDM channels; and
   an unused channel restoration section for restoring an unused channel from the plurality of TDM channels accommodated in a received compressed packet by referring to the unused-channel information, to generate a standard-compliant packet accommodating the predetermined number of TDM channels.

### (Supplementary Note 25)

A program stored in a non-transitory recording medium in a transmission device for transmitting a packet to a destination transmission device through an asynchronous network, the packet accommodating a plurality of time division multiplexing (TDM) channels, the program comprising:
storing unused-channel information on an unused one of a predetermined number of TDM channels; and
deleting an unused channel from the predetermined number of TDM channels accommodated in a received packet by referring to the unused-channel information, to generate a compressed packet to transmit to the destination transmission device.

### (Supplementary Note 26)

A program stored in a non-transitory recording medium in a transmission device for receiving a packet from a source transmission device through an asynchronous network, the packet accommodating a plurality of time division multiplexing (TDM) channels, the program comprising:
storing unused-channel information on an unused one of a predetermined number of TDM channels; and
restoring an unused channel from the plurality of TDM channels accommodated in a received compressed packet by referring to the unused-channel information, to generate a standard-compliant packet accommodating the predetermined number of TDM channels.

The present invention is applicable to transmission devices in a SAToP transmission system.

The present invention may be embodied in other specific forms without departing from the spirit or essential characteristics thereof. The above-described exemplary embodiment and examples are therefore to be considered in all respects as illustrative and not restrictive, the scope of the invention being indicated by the appended claims rather than by the foregoing description, and all changes which come within the meaning and range of equivalency of the claims are therefore intended to he embraced therein.

1. A transmission device for transmitting a packet to a destination transmission device through an asynchronous network, the packet accommodating a plurality of time division multiplexing (TDM) channels, comprising:
an unused-channel information storage section for storing unused-channel information on an unused one of a predetermined number of TDM channels; and
an unused channel deletion section for deleting an unused channel from the predetermined number of TDM channels accommodated in a received packet by referring to the unused-channel information, to generate a compressed packet to transmit to the destination transmission device.

2. The transmission device according to claim 1, wherein the unused channel deletion section deletes a time slot corresponding to the unused channel to generate the compressed packet.

3. The transmission device according to claim 1, wherein the unused-channel information indicates an unused channel for each destination transmission device.

4. The transmission device according to claim 1, wherein the unused-channel information is determined based on channel setting information set in a pseudo wire emulation device which converts TDM data to pseudo wire emulation data.

5. The transmission device according to claim 1, wherein the asynchronous network is a packet network or an Ethernet-compliant network.

6. A transmission device for receiving a packet from a source transmission device through an asynchronous network, the packet accommodating a plurality of time division multiplexing (TDM) channels, comprising:
an unused-channel information storage section for storing unused-channel information on an unused one of a predetermined number of TDM channels; and
an unused channel restoration section for restoring an unused channel from the plurality of TDM channels accommodated in a received compressed packet by referring to the unused-channel information, to generate a standard-compliant packet accommodating the predetermined number of TDM channels.

7. The transmission device according to claim 6, wherein the unused channel restoration section adds a time slot corresponding to the unused channel to time slots each corresponding to the plurality of TDM channels, to generate the standard-compliant packet.

8. The transmission device according to claim 6, wherein the unused-channel information is determined based on channel setting information set in a pseudo wire emulation device which converts pseudo wire emulation data to TDM data.

9. The transmission device according to claim 6, wherein the asynchronous network is a packet network or an Ethernet-compliant network.

10. A transmission method of transmission of a packet from a sending-side transmission device to a receiving-side transmission device through an asynchronous network, the packet accommodating a plurality of time division multiplexing (TDM) channels, comprising:
at the sending-side transmission device,
storing unused-channel information on an unused one of a predetermined number of TDM channels;
receiving a standard-compliant packet accommodating the predetermined number of TDM channels;
deleting an unused channel from the predetermined number of TDM channels accommodated in the received standard-compliant packet by referring to the unused-channel information, to generate a compressed packet;
transmitting the compressed packet to the receiving-side transmission device;
at the receiving-side transmission device,
storing the unused-channel information;
receiving the compressed packet from the sending-side transmission device; and
restoring the unused channel from the plurality of TDM channels accommodated in the received compressed packet by referring to the unused-channel information, to generate a standard-compliant packet accommodating the predetermined number of TDM channels.

11. The transmission method according to claim 10, wherein the compressed packet is generated by deleting a time slot corresponding to the unused channel and the standard-compliant packet is generated by adding a time slot corresponding to the unused channel to time slots each corresponding to the plurality of TDM channels accommodated in the received compressed packet.

12. The transmission method according to claim 10, wherein the unused-channel information indicates an unused channel for each destination transmission device.

13. The transmission method according to claim 10, wherein the unused-channel information is determined based on channel setting information set in a pseudo wire emulation device which makes conversion between TDM data and pseudo wire emulation data.

14. The transmission method according to claim 10, wherein the asynchronous network is a packet network or an Ethernet-compliant network.
